(19) United States
(12) Patent Application Publication
(10) Pub. No.: US 2023/0046888 A1
(43) Pub. Date: Feb. 16, 2023

(54) METHODS OF RECOVERING A METAL FROM A METAL-CONTAINING WASTE MATERIAL AND RELATED ELECTROCHEMICAL CELLS

(71) Applicant: Battelle Energy Alliance, LLC, idaho Falls, ID (US)

(72) Inventor: Prabhat K. Tripathy, idaho Falls, ID (US)

(21) Appl. No.: 17/819,239

(22) Filed: Aug. 11, 2022

Related U.S. Application Data
(60) Provisional application No. 63/231,960, filed on Aug. 11, 2021.

(51) Int. Cl. C25C 3/28; C25C 7/00

(52) U.S. Cl. CPC C25C 3/28; C25C 7/005

(57) ABSTRACT

A method of recovering a metal from a metal-containing waste material comprises heating a metal-containing waste material under a hydrogen flow to form a hydrided metal material. Hydrogen is removed from the hydrided metal material to form an elemental metal or a metal oxide. Additional methods are disclosed, as are related electrochemical cells.

### CROSS-REFERENCE TO RELATED APPLICATION

This application claims the benefit under 35 U.S.C. § 119(e) of U.S. Provisional Pat. Application Serial No. 63/231,960, filed Aug. 11, 2021, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05ID14517 awarded by the United States Department of Energy. The government has certain rights in the invention.

### TECHNICAL FIELD

The disclosure, in various embodiments, relates to methods of recovering a metal from a metal-containing material.

### BRIEF SUMMARY

A method of recovering a metal from a metal-containing waste material is disclosed and comprises heating a metal-containing waste material under a hydrogen flow to form a hydrided metal material. Hydrogen is removed from the hydrided metal material to form an elemental metal or a metal oxide.

Another method of recovering a metal from a metal-containing waste material is disclosed and comprises imposing an electrochemical environment upon a metal oxide material in a basket of an electrochemical cell immersed in a molten salt electrolyte. The molten salt electrolyte comprises a CaCl₂/CaO electrolyte composition, wherein the CaO constitutes between about 0.25 wt. % and about 5.0 wt. % of the molten salt electrolyte, and the CaCl₂ comprises up to 99.75 wt. % of the molten salt electrolyte. The electrochemical cell comprises a counter electrode comprising a nonmetal selected from a ceramic selected from tin oxide, zinc ferrite, nickel ferrite, lithium ferrite, and samarium ferrite, a carbonaceous material, or a metal selected from palladium, platinum, ruthenium, rhenium and iridium. The metal oxide material is reduced to a reduced metal in the molten salt electrolyte, where the reduced metal is selected from a transition metal, a refractory metal and a rare earth metal.

An electrochemical cell is disclosed and comprises a working electrode immersed in a molten salt electrolyte, the molten salt electrolyte comprising at least one of an alkali halide salt and an alkaline earth metal halide salt. A metal compound comprising an oxidized metal or a partially hydrided metal is in a basket located within the molten salt electrolyte. The working electrode is in electrochemical contact with the metal compound and the basket. A counter electrode is immersed in the molten salt electrolyte and comprises at least one material selected from graphite, lithium iridate, lithium ruthenate, lithium rhodate, a tin oxide compound, a lithium tin oxygen compound, a lithium manganese oxygen compound, calcium ruthenate, a strontium ruthenium ternary compound, calcium iridate, strontium iridate, calcium platinate, strontium platinate, magnesium ruthenate, magnesium iridate, sodium ruthenate, sodium iridate, potassium iridate, potassium ruthenate, and selected nickel superalloys. The electrochemical cell also includes a reference electrode selected from glassy carbon, nickel, nickel/nickel oxide, silver/silver chloride, a platinum group metal, a precious metal, and combinations thereof and an inert atmosphere.

### BRIEF DESCRIPTION OF THE DRAWINGS

FIG. 1 is a simplified schematic view of an electrochemical cell for recovering metals in a waste metal material using a molten salt electrolyte according to several embodiments.

FIG. 2 is a simplified process flow diagram of a molten electrolyte method of refining an oxidized waste metal according to several embodiments.

FIG. 3 is a simplified process flow diagram of a selective hydriding method of refining a waste metal according to several embodiments.

### DETAILED DESCRIPTION

As used herein, the term “transition metal” means and includes scandium, titanium, vanadium, chromium, manganese, iron, cobalt, nickel, copper, zinc, yttrium, zirconium, niobium, molybdenum, ruthenium, rhodium, palladium, silver, cadmium, lanthanum, hafnium, tantalum, tungsten, rhenium, osmium, iridium, platinum, or gold.

As used herein, the term “refractory metal” means and includes titanium, vanadium, chromium, manganese, zirconium, niobium, molybdenum, ruthenium, rhodium, hafnium, tantalum, tungsten, rhenium, osmium, or iridium.

As used herein, the term “rare earth element” means and includes cerium, dysprosium, erbium, europium, gadolinium, holmium, lanthanum, lutetium, neodymium, praseodymium, promethium, samarium, scandium, terbium, thulium, ytterbium, or yttrium. The rare earth element includes one of the lanthanide (Ln) elements, scandium, or yttrium.

A metal, such as a transition metal, a refractory metal, a rare earth metal, or a metal oxide, or a metal alloy of these metals may be recovered from a material (e.g., a waste material, a waste metal material) that includes one or more oxidized metals, such as from a waste metal or waste metal alloy. Processing may include molten electrolyte reduction of waste metal oxides. Processing may alternatively include anhydrous hydriding of waste metals. In some embodiments, both hydriding and molten electrolyte reduction may be combined.

For electrorefining of waste metals, the waste material may be subjected to a molten salt electrolyte bath under an electrical potential and current to reduce the oxidized waste materials and to plate a reduced metal onto a working electrode. Alternatively, the waste material can form the electrode (cathode) from which oxygen can be selectively removed by cathodic polarization. For hydriding reclamation of waste metals, the waste material may be subjected to selective hydriding of target metals from waste metals and waste metal compounds that may be separated from the selectively hydrided metals.

The waste material may contain partially- or completely oxidized compounds of the metal. Depending on the chemical composition(s) of materials in the waste material, the one or more metal oxides may be recovered by reacting the waste material with a reactive gas, such as hydrogen gas (H2), or by cathodic polarization of the one or more metal oxides in the molten salt electrolyte.

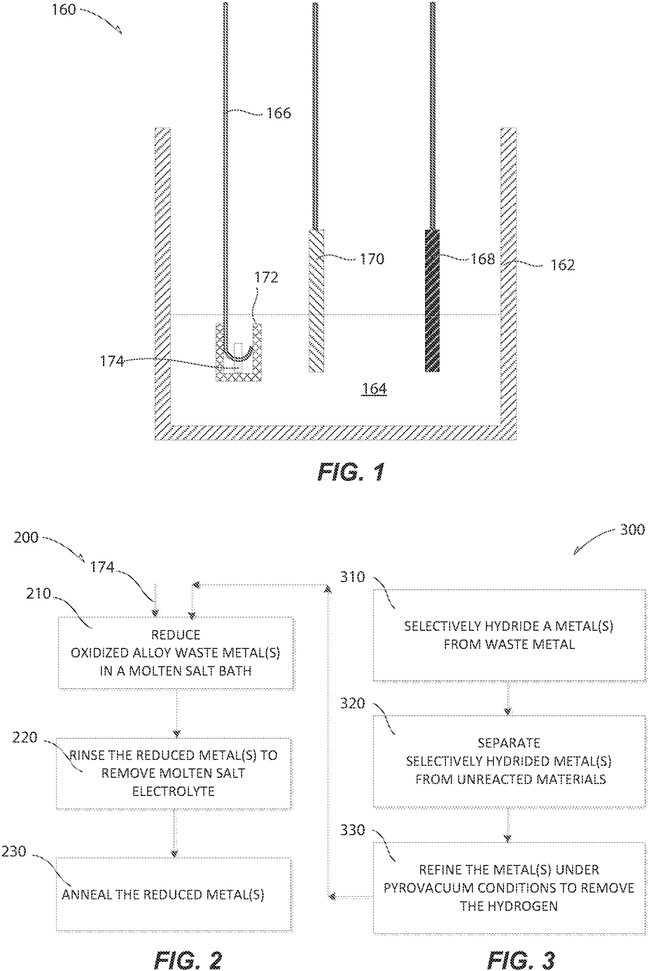

Referring to FIGS. 1 and 2, the electrorefining reduction of the metal oxide(s) (e.g., oxidized metal(s)) in the waste material and the formation of the metal alloy(s) is illustrated. FIG. 2 is a simplified process flow diagram of a method 200 of electrorefining an oxidized metal according to several embodiments. Oxidized waste metal(s) 174 (also referred to as metal compound(s) 174), whether a single metal or an alloy is supplied at 174 to a molten salt treatment bath at 210 to reduce the metal oxide to the metal. At step 220, processing includes rinsing the formerly oxidized waste metal(s) for further refining. At step 230, processing includes annealing the rinsed metal(s). In some embodiments, annealing processing includes annealing in reducing conditions, such as annealing in an inert atmosphere such as in helium/argon.

Referring to FIG. 1, electrorefining of a waste metal is conducted in an electrochemical cell 160 that includes a crucible 162, a working electrode (also referred to as a cathode) 166, a counter electrode (also referred to as an anode) 168, an electrolyte (e.g., a molten salt electrolyte 164), and a reference electrode 170. As shown in FIG. 1 in some embodiments, the cathode 166 functions as the material (e.g., substrate, wire) to be plated with the reduced metal or metal alloy(s) derived from the oxide waste metal(s) or oxidized waste material(s). The electrochemical cell 160 may be housed in an atmosphere-protected environment such as a “glove box,” such as an argon atmosphere glove box, to reduce exposure of sensitive components to moisture and/or oxygen. The crucible 162 is configured to contain the molten salt electrolyte 164 and a basket 172 that contains metal oxide(s) 174 for reducing the metal oxide(s) 174 and for plating the reduced metal(s) onto the working electrode 166. Each of the working electrode 166, the counter electrode 168, and the reference electrode 170 is at least partially disposed in the molten salt electrolyte 164 and in electrochemical contact with the molten salt electrolyte 164. The molten salt electrolyte 164 may function as a solvent as well as to remove oxygen from the metal oxide(s) 174. When an electrical potential is applied between the working electrode 166 and the counter electrode 168, the metal oxide(s) of the waste metal oxide(s) 174 may be reduced in the electrochemical cell 160. Processing may also be illustrated in simplified form in FIG. 2, where molten electrolyte refining is depicted at 210, where waste metal oxide(s) 174 are charged to the basket 172 that is immersed in the molten salt electrolyte 164 (FIG. 1).

The molten salt electrolyte 164 may be established a temperature of from about 350° C. to about 450° C. when used to reduce the metal oxide(s) 174 and to plate the resulting metal(s) onto the working electrode 166. Alternately, higher temperatures may be used, for example, up to about 950° C. In some embodiments, the molten salt electrolyte 164 may be formulated to exhibit a melting temperature within a range of from about 550° C. to about 950° C., such as from about 550° C. to about 650° C., from about 650° C. to about 750° C., from about 750° C. to about 850° C., or from about 850° C. to about 950° C. The molten salt electrolyte 164 may be maintained at a temperature such that the molten salt electrolyte 164 is, and remains, in a molten state. In other words, the temperature of the metal oxide(s) 174 may be maintained at or above a melting temperature of the molten salt electrolyte 164. However, the use of lower temperatures may be advantageous. For example, keeping the molten salt electrolyte 164 at a lower temperature may utilize less energy.

Also, a wider variety of working electrodes 166 may be useful for reduction of the metal oxide(s) 174 with the lower temperatures in the 350° C. to about 450° C. temperature range. For example, the working electrode 166 may be the same material as the target metal to be reduced and refined from the metal oxide(s) 174. For reducing the metal oxide(s) 174 and/or plating the resulting metal(s) onto the working electrode 166, the current density may be between about 150 Amp/ft² and about 300 Amp/ft². The current density may be between about 200 Amp/ft² and about 300 Amp/ft². The current density may also be adjusted based upon the remaining amount of metal oxide(s) 174 within the basket 172 as amounts decrease toward a depleted amount of the metal oxide(s) 174. The current density may also be adjusted based upon the composition of the molten salt electrolyte 164 and electrolysis temperature.

In other examples, agitation of the molten salt electrolyte 164 may be conducted to make contact of unreacted molten salt electrolyte 164 with as-yet unreduced metal oxide(s) 174 so as to retain a quasi-batch stirred-tank reactor (BSTR) environment within the molten salt electrolyte 164 and the remaining unoxidized metal oxide(s) 174. Useful agitation amounts may depend, in part, on the composition and viscosity of the molten salt electrolyte 164 in a dynamically changing BSTR environment. In some embodiments, agitation may be done by external processes such as by inductive stirring. The quasi BSTR environment may be changed by feeding more of the working electrode 166 into the molten salt electrolyte 164 and into the basket 172, as the metal oxide(s) 174 are reduced and depleted from an original amount charged to the basket 172.

The crucible 162 may be formed of and include a ceramic material (e.g., alumina, magnesia (MgO), boron nitride (BN)), graphite, or a metallic material (e.g., nickel, stainless steel, molybdenum, or an alloy of nickel including chromium and iron, such as Inconel®, commercially available from Special Metals Corporation of New Hartford, New York).

The counter electrode 168 may be a carbonaceous material or a non-carbonaceous material. The counter electrode 168 may be formed of and include one or more of graphite (e.g., high density graphite), a platinum group metal (e.g., platinum, osmium, iridium, ruthenium, rhodium, and palladium), an oxygen evolving electrode, or another material. By way of example only, the counter electrode 168 may be formed of and include osmium, ruthenium, rhodium, iridium, palladium, platinum, silver, gold, lithium iridate (Li₂IrO₃), lithium ruthenate (Li₂RuO₃), a lithium rhodate (LiRh0₂, LiRhO₃), a lithium tin oxygen compound (e.g., Li₂SnO₃), a lithium manganese oxygen compound (e.g., Li₂MnO₃), calcium ruthenate (CaRuO₃), strontium ruthenium ternary compounds (e.g., SrRuO₃, Sr₂RuO₃, Sr₂RuO₄), CaIrO₃, strontium iridate (e.g., SrIrO₃, SrIrO₄, Sr₂IrO₄), calcium platinate (CaPtO₃), strontium platinate (SrPtO₄), magnesium ruthenate (MgRuO₄), magnesium iridate (MgIrO₄), sodium ruthenate (Na₂RuO₄), sodium iridate (Na₂IrO₃), potassium iridate (K₂IrO₃), or potassium ruthenate (K₂RuO₄). In some embodiments, the counter electrode 168 comprises graphite. In other embodiments, the counter electrode 168 comprises one or more platinum group metals. If the counter electrode 168 comprises iridium or ruthenium, the methods according to embodiments of the disclosure may be substantially nonpolluting. In some embodiments, the counter electrode 168 comprises one or more platinum group metals (e.g., ruthenium, rhodium, palladium, osmium, iridium, and platinum), and one or more transition metals.

In some embodiments, the counter electrode 168 comprises nickel-based superalloys, particularly solid solution strengthened and age-hardened type nickel-based superalloys. The Table provides selected nickel superalloy compositions for some embodiments of the counter electrode 168. Where ranges of certain additive metals are given, the base material of nickel (Ni) is adjusted to reach approximately 100 wt. %.

| Alloy | Ni | Cr | Co | Mo | Ti | Al | w | C | Ta | Hf | Re | Ru |
|---|---|---|---|---|---|---|---|---|---|---|---|---|
| Udimet | 57.4 | 16 | 15 | 3 | 5 | 2.5 | 1 | 0.1 | 0 | 0 | 0 | 0 |
| RR1000 | 52.37 | 15 | 18.5 | 5 | 3.6 | 3 | 0 | 0.03 | 2 | 0.5 | 0 | 0 |
| Nimonic 80A | 76.7 | 19.5 | 0 | 0 | 2.4 | 1.4 | 0 | 0 | 0 | 0 | 0 | 0 |
| Nimonic 105 | 54 | 15 | 20 | 5 | 1.3 | 4.7 | 0 | 0 | 0 | 0 | 0 | 0 |
| *With Re | 61 | 6.2 | 9.3 | 0.6 | 1 | 5.7 | 6.3 | | 6.9 | 0.1 | 2.9 | 0 |
| **With Re- Ru | 61 | 6.2 | 9.3 | 0.6 | 1 | 5.7 | 6.3 | | 6.9 | 0.1 | 1.4 | 1.5 |

* Up to 6 wt. % rhenium. **Total of rhenium and ruthenium varied, totaling 6 wt. %

The reference electrode 170 may comprise any suitable material and is configured for monitoring a potential in the electrochemical cell 160. In some embodiments, the reference electrode 170 comprises glassy carbon. The reference electrode 170, may be in electrical communication with the counter electrode 168 and the working electrode 166 and may be configured to assist in monitoring the potential difference between the counter electrode 168 and the working electrode 166. Accordingly, the reference electrode 170 may be configured to monitor the cell potential of the electrochemical cell 160. The reference electrode 170 may include nickel, nickel/nickel oxide, glassy carbon, silver/silver chloride, one or more platinum group metals, one or more precious metals (e.g., gold), or combinations thereof. In some embodiments, the reference electrode 170 comprises glassy carbon. In other embodiments, the reference electrode 170 comprises nickel, nickel oxide, or a combination thereof. In yet other embodiments, the reference electrode 170 comprises silver/silver chloride.

A potentiostat or a DC power supply (not illustrated) may be electrically coupled to each of the counter electrode 168, the working electrode 166, and the reference electrode 170. The potentiostat may be configured to measure and/or provide an electric potential between the counter electrode 168 and the working electrode 166. The difference between the electric potential of the counter electrode 168 and the electric potential of the working electrode 166 may be referred to as a cell potential of the electrochemical cell 160.

The electrolyte 164 may be disposed within the crucible 162 and may include a material formulated to facilitate reduction of the metal oxide(s) of the waste material 174. The electrolyte 164 may comprise, for example, a molten salt, such as an alkali halide salt, an alkaline earth metal halide salt, an alkali oxide, an alkaline earth metal oxide, or combinations thereof. The molten salt electrolyte 164 may be formed of and include lithium chloride (LiCl), lithium oxide (Li₂O), sodium chloride (NaCl), calcium chloride (CaCl₂), calcium oxide (CaO), lithium bromide (LiBr), potassium bromide (KBr), cesium bromide (CsBr), calcium bromide (CaBr₂), potassium chloride (KCl), potassium bromide (KBr), strontium chloride (SrCl₂), strontium bromide (SrBr₂), or a combination thereof. The molten salt electrolyte 164 may be a CaCl₂ electrolyte, such as a CaCl₂/CaO electrolyte. In some such embodiments, the calcium oxide constitutes between about 0.25 weight percent (wt. %) and about 5.0 wt. % of the molten salt electrolyte 164, such as between about 0.5 wt. % and about 2.0 wt. %, or between about 1.5 wt. % and about 2.5 wt. % of the molten salt electrolyte 164. The calcium chloride may constitute a remainder of the molten salt electrolyte 164. In some embodiments, the calcium oxide constitutes about 1.0 wt. % of the molten salt electrolyte 164.

The electrolyte 164 may be formulated to exhibit a melting temperature within a range of from about 550° C. to about 950° C., such as from about 550° C. to about 650° C., from about 650° C. to about 750° C., from about 750° C. to about 850° C., or from about 850° C. to about 950° C.

The current collector of the working electrode 166 may comprise, for example, a wire. The current collector of the working electrode 166 may be coupled to the basket 172 configured to contain the metal oxide(s) 174 of the waste material. In some embodiments, the basket 172 comprises a wire basket 172 and comprises the same material composition as the current collector of the working electrode 166.

The metal oxide(s) 174 may be coupled to (e.g., directly in contact with) at least one of the current collectors of the working electrode 166 and the basket 172. In some embodiments, the metal oxide(s) 174 includes a portion sized and shaped to receive a portion of the current collector of the working electrode 166. By way of non-limiting example, a portion of the current collector of the working electrode 166 may be fed through a portion of the metal oxide(s) 174 within the basket 172. As one example, the electrochemical cell 160 may include an aperture (not illustrated) configured to receive the portion of the current collector of the working electrode 166, while the working electrode 166 continuously contacts the metal oxide(s) 174.

After processing to reduce the metal oxide(s) 174 to obtain metal(s), further processing may be done. During electrorefining, a more porous reduced metal(s) may plate onto the working electrode 166. The reduced metal(s) may be cleaned by removing any salt from both the surface of the plated metal(s) as well as where the plated metal(s) are porous, to remove any salt from porous internal surfaces of the plated metal(s). For example, as illustrated in FIG. 2, at step 220, rinsing techniques are depicted in simplified form. In some embodiments, the plated metal(s) on the working electrode 166, are placed into a water bath to remove by water dissolution chemistry, substantially all or most of the remaining salt of the electrolyte 164.

In some embodiments, the reduced metal(s) are placed in an oven and annealed (e.g., heated) in an inert atmosphere to volatilize residual salt of the electrolyte 164. After cleaning the reduced metal(s) on the working electrode 166, a process may be done to anneal the reduced metal(s) under conditions to refine the reduced metal(s) to commercial product quality. For example, as illustrated in FIG. 2 at step 230, annealing techniques are conducted. In some embodiments, a product of the reduced metal(s) is annealed to obtain a useful metal grain morphology. In some embodiments, a product of the reduced metal(s) is annealed to obtain a useful purity of the reduced metal(s) by further expelling unwanted residual material from earlier processing. In some embodiments, a product of the reduced metal(s) is annealed to obtain a useful metal density, where porosity and macro dislocations such as pinholes of the reduced metal(s) are substantially removed.

In some embodiments, selective hydriding of waste metal is done where the waste metal material(s) is in a different state of oxidation and/or other contamination than the waste metal oxide materials disclosed herein. Referring in part to FIG. 3, the waste metal material is subjected to heating under a continuous anhydrous hydrogen flow and target metal(s) are selectively hydrided. In some embodiments with a continuous anhydrous hydrogen flow, the waste metal material may also be further electrorefined as set forth above and illustrated in FIGS. 1 and 2.

After selectively hydriding the waste metal(s), separation techniques may be conducted to concentrate hydrided waste metals. The separation process may be a density differential technique, such as a density differential separation, such as by gravity, agitation motion, or a liquid-medium to fluidize the product stream and to separate the desired product of concentrated hydrided metal. Alternatively, the separation process may include an acid bath treatment where the hydrided reactants are subjected to the acid bath to dissolve the one or more of the unhydrided materials and to leave the hydrided metals.

After separation of the hydrided waste metal(s), refining techniques such as pyrovacuum refining may be used to remove the hydrogen from the metal(s) to attain a product metal. In some embodiments, temperatures for pyrovacuum heating are established at above chemisorption thermal equilibrium temperatures where a hydrided metal releases the adsorbed hydrogen, in a range from about 1% above chemisorption thermal equilibrium to about 40% chemisorption thermal equilibrium. In some embodiments, the pyrovacuum heating is done in a range from about 100° C. to about 1,200° C. Process parameters include establishing the vacuum (lowering pressure within the reactor vessel below ambient) to create a desorption gradient, heating to create a desorption gradient, and time periods in connection with the lowered pressure and increased temperature.

FIG. 3 is a simplified process flow diagram of a method 300 of refining a metal from a waste feedstock by selectively hydriding the waste metal feedstock. In non-limiting example embodiments set forth herein (e.g., Examples 1-12), several example embodiments set forth below, are commenced by selectively hydriding a metal.

At processing stage 310, the method includes selectively hydriding the waste metal feedstock. At processing stage 320, the method includes physically separating selectively hydrided metal(s) from unreacted materials. In non-limiting example embodiments, any of the Examples 1 through 12 set forth below, is used to physically separate hydrided products from unhydrided products by separating a fluidized product stream from gangue. In non-limiting example embodiments, any of the Examples 1 through 12 set forth below, is used to chemically separate hydrided metal(s) by dissolution and removal of unreacted materials. In some embodiments, the hydrided metal is neodymium hydride. In some embodiments, the hydrided metal is platinum hydride. In some embodiments, the hydrided metal is titanium hydride.

At processing stage 330, the method includes refining the hydrided metal(s) by subjecting the products to a pyrovacuum process, where at an elevated temperature such as at 750° C., the hydrogen is removed from the metal(s) to form the elemental metal or metal oxide. In some embodiments, processing is completed at processing stage 330.

The unhydrided metal(s) at processing stage 330 may additionally and alternatively be subjected to cathodic polarization of the molten salt electrolyte against a counter electrode (e.g., an anode material) of an electrochemical cell as illustrated in FIGS. 1 and 2 where the unhydrided metal(s) at processing stage 330, are fed to the processing stage 210 (see, e.g., Examples 7-12).

During anhydrous treatment of a given waste metal, selective hydriding of metals in the waste material occurs, with a selected metal being hydrided, and other materials of the waste material not being hydrided. For example, a transition metal waste material such as an iron neodymium-based waste material, may be treated to selectively hydride the neodymium without hydriding the iron. Similarly for example, a refractory metal waste material such as a titanium-based material may be treated to selectively hydride the titanium but not other metals (such as aluminum, nickel, cobalt, gallium) that may be present in the refractory waste material. Similarly for example, a rare earth metal waste material such as a cerium-based material may be treated to selectively hydride the cerium but no other metals that may be present in the rare earth waste material.

In some embodiments, a temperature is selected between ambient temperature (between about 20° C. and about 25° C.) and about 1,000° C. during the anhydrous hydrogen flow. Temperature control may be used depending upon the feed waste metal type(s) that are subjected to hydriding. Further, anhydrous hydrogen concentrations may be selected by controlling pressure within a hydriding reactor container. For example, a substantially 100% anhydrous hydrogen flow may be increased in hydrogen density by altering the pressure of the anhydrous hydrogen, and a pressure is selected between ambient pressure and about 3 atmospheres (atm). An amount of time for the hydriding may be conducted based upon the metallic type of waste metal feed and the state of the waste metal feed such as oxidation or other conditions such as impurity concentrations. In some embodiments, the sample is heated under vacuum for several hours prior to its exposure to hydrogen to form the selective metal hydrides.

The following examples serve to explain embodiments of the disclosure in more detail. These examples are not to be construed as being exhaustive or exclusive as to the scope of this disclosure.

### Example 1

A crushed iron neodymium boron magnet waste metal material is heated in a reactor vessel in a range between ambient temperature and 500° C., a 1.1 atmosphere (atm, gauge) pressure, and a 100% anhydrous hydrogen stream is circulated within a closed rector. The crushed iron neodymium boron magnet waste material is at a particle size passing 100 mesh. Monitoring of pressure in the closed reactor leads to process control of adding anhydrous hydrogen as a pressure drop occurs where hydrogen selectively hydrides the neodymium without significant hydriding of the iron and the boron. After a time period of observed pressure drop, a bleed stream is released until slightly above ambient pressure is observed, about 1% to 5% above the ambient, followed by a make-up stream of hydrogen that is added to the selected pressure set point such as 1.1 atm (gauge pressure compared to ambient at a nominal 1.0 atm).

After at least two cycles of hydriding, bleed, and make-up of the anhydrous hydrogen, the processed waste metal material is subjected to a separation process. In some embodiments, three cycles of hydriding are done. In some embodiments, a single cycle of hydriding is done, followed by separation and pyrovacuum refining.

A separation process is done by use of a density differential separation, such as by gravity in a cyclone and an inert-gas atmosphere, to fluidize the product stream and to separate the desired product of concentrated hydrided neodymium. Thereafter, the concentrated hydrided neodymium is placed in a pyrovacuum heating refinery. Under pyrovacuum heating conditions, the hydrogen of the hydrided neodymium is expelled, and a neodymium powder metal remains as a product.

Alternatively, a separation process is done by use of an acid bath treatment where the hydrided reactants are subjected to the acid bath to dissolve the iron and boron and to leave the hydrided neodymium. Thereafter, the concentrated hydrided neodymium is placed in a pyrovacuum heating refinery. Under pyrovacuum heating conditions, the hydrogen of the hydrided neodymium is expelled, and a neodymium powder metal remains as a product.

### Example 2

A crushed iron neodymium boron magnet waste metal material is heated in a reactor vessel in a range between ambient temperature and 100° C., a 1.1 atm pressure, and a 100% anhydrous hydrogen stream is circulated within a closed rector. The crushed iron neodymium boron magnet waste material is at a particle size passing 400 mesh. All other process acts and conditions used in Example 1 are then followed.

### Example 3

A crushed samarium-cobalt alloy waste metal material is heated in a reactor vessel in a range between ambient temperature and 500° C., a 1.1 atm pressure, and a 100% anhydrous hydrogen stream is circulated within a closed rector. The crushed samarium-cobalt alloy waste material is at a particle size passing 100 mesh.

Monitoring of pressure in the closed reactor leads to process control of adding anhydrous hydrogen as a pressure drop occurs where hydrogen selectively hydrides the samarium without significant hydriding of the cobalt. After a time period of observed pressure drop, a bleed stream is released until slightly above ambient pressure is observed, about 1% to 5% above the ambient, followed by a make-up stream of hydrogen that is added to the selected pressure set point such as 1.1 atm (gauge pressure compared to ambient at a nominal 1.0 atm).

After at least two cycles of hydriding, bleed, and makeup of the anhydrous hydrogen, the processed waste metal material is subjected to a separation process. In some embodiments, three cycles of hydriding are done. In some embodiments, a single cycle of hydriding is done, followed by separation and pyrovacuum refining.

A separation process is done by a density differential technique, which is done such as by gravity, agitation motion, and a liquid-medium to fluidize the product stream, and the desired product of concentrated hydrided samarium is placed in a pyrovacuum heating refinery. Under pyrovacuum heating conditions, the hydrogen of the hydrided samarium is expelled, and a samarium powder metal remains as a product.

Alternatively, a separation process is done by use of an acid bath treatment where the hydrided reactants are subjected to the acid bath to dissolve cobalt and to leave the hydrided samarium. Thereafter, the concentrated hydrided samarium is placed in a pyrovacuum heating refinery. Under pyrovacuum heating conditions, the hydrogen of the hydrided samarium is expelled, and a samarium powder metal remains as a product.

### Example 4

A crushed samarium-cobalt alloy waste metal material is heated in a reactor vessel in a range between ambient temperature and 100° C., a 1.1 atm pressure, and a 100% anhydrous hydrogen stream is circulated within a closed rector. The crushed samarium-cobalt alloy waste material is at a particle size passing 400 mesh. All other process acts and conditions used in Example 3 are then followed.

### Example 5

A crushed platinum-cobalt alloy waste metal material is heated in a reactor vessel in a range between ambient temperature and 500° C., a 1.1 atm pressure, and a 100% anhydrous hydrogen stream is circulated within a closed rector. The crushed platinum-cobalt alloy waste material is at a particle size passing 100 mesh. Monitoring of pressure in the closed reactor leads to process control of adding anhydrous hydrogen as a pressure drop occurs where hydrogen selectively hydrides the platinum without significant hydriding of the cobalt. After a time period of observed pressure drop, a bleed stream is released until slightly above ambient pressure is observed, about 1% to 5% above the ambient, followed by a make-up stream of hydrogen that is added to the selected pressure set point such as 1.1 atm.

After at least two cycles of hydriding, bleed, and makeup of the anhydrous hydrogen, the processed waste metal material is subjected to a separation process. In some embodiments, three cycles of hydriding are done. In some embodiments, a single cycle of hydriding is done, followed by separation and pyrovacuum refining.

A separation process is done by a density differential technique, which is done such as by gravity, agitation motion, and a liquid-medium to fluidize the product stream, and the desired product of concentrated hydrided platinum is placed in a pyrovacuum heating refinery. Under pyrovacuum heating conditions, the hydrogen of the hydrided platinum is expelled, and a platinum powder metal remains as a product.

Alternatively, a separation process is done by use of an acid bath treatment where the hydrided reactants are subjected to the acid bath to dissolve cobalt and to leave the hydrided platinum. Thereafter, the concentrated hydrided platinum is placed in a pyrovacuum heating refinery. Under pyrovacuum heating conditions, the hydrogen of the hydrided platinum is expelled, and a platinum powder metal remains as a product.

### Example 6

A crushed platinum-cobalt alloy waste metal material is heated in a reactor vessel in a range between ambient temperature and 100° C., a 1.1 atm pressure, and a 100% anhydrous hydrogen stream is circulated within a closed rector. The crushed platinum-cobalt alloy waste material is at a particle size passing 400 mesh. All other process acts and conditions used in Example 5 are then followed, and each separation process alternative is then followed.

### Example 7

A crushed nickel-titanium/iron titanium/aluminum-titanium alloy waste metal materials are heated in a reactor vessel in a range between ambient temperature and 500° C., a 1.1 atm pressure, and a 100% anhydrous hydrogen stream is circulated within a closed rector. The nickel-titanium/iron titanium/aluminum-titanium alloy waste materials are at a particle size passing 100 mesh.

Monitoring of pressure in the closed reactor leads to process control of adding anhydrous hydrogen as a pressure drop occurs where hydrogen selectively hydrides the titanium without significant hydriding of the nickel, the iron and the aluminum. After a time period of observed pressure drop, a bleed stream is released until slightly above ambient pressure is observed, about 1% to 5% above the ambient, followed by a make-up stream of hydrogen that is added to the selected pressure set point such as 1.1 atm.

After at least two cycles of hydriding, bleed, and makeup of the anhydrous hydrogen, the processed waste metal material is subjected to a separation process. Three cycles of hydriding are done or a single cycle of hydriding is done, followed by separation and pyrovacuum refining.

A separation process is done by a density differential technique, which is done such as by gravity, agitation motion, and a liquid-medium to fluidize the product stream, and the desired product of concentrated hydrided titanium is placed in a pyrovacuum heating refinery. Under pyrovacuum heating conditions, the hydrogen of the hydrided titanium is expelled, and a titanium powder metal remains as a product.

Alternatively, a separation process is done by use of an acid bath treatment where the hydrided reactants are subjected to the acid bath to dissolve cobalt and to leave the hydrided titanium. Thereafter, the concentrated hydrided titanium is placed in a pyrovacuum heating refinery. Under pyrovacuum heating conditions, the hydrogen of the hydrided titanium is expelled, and a titanium powder metal remains as a product.

Titanium powder metal may be further refined after pyrovacuum heating, by charging the basket 172 (FIG. 1) with the titanium powder metal 174, and by electrochemically further refining within the molten salt electrolyte 164.

### Example 8

A crushed nickel-titanium/iron titanium/aluminum-titanium alloy waste metal materials are heated in a reactor vessel in a range between ambient temperature and 100° C., a 1.1 atm pressure, and a 100% anhydrous hydrogen stream is circulated within a closed rector. The nickel-titanium/iron titanium/aluminum-titanium alloy waste materials are at a particle size passing 400 mesh. All other process acts and conditions used in Example 7 are then followed, and each separation process alternative is then followed.

### Example 9

A crushed zirconium-aluminum alloy waste metal material is heated in a reactor vessel in a range between ambient temperature and 500° C., a 1.1 atm pressure, and a 100% anhydrous hydrogen stream is circulated within a closed rector. The zirconium-aluminum alloy waste materials is at a particle size passing 100 mesh.

Monitoring of pressure in the closed reactor leads to process control of adding anhydrous hydrogen as a pressure drop occurs where hydrogen selectively hydrides the zirconium without significant hydriding of the aluminum. After a time period of observed pressure drop, a bleed stream is released until slightly above ambient pressure is observed, about 1% to 5% above the ambient, followed by a make-up stream of hydrogen that is added to the selected pressure set point such as 1.1.

After at least two cycles of hydriding, bleed, and makeup of the anhydrous hydrogen, the processed waste metal material is subjected to a separation process. Three cycles of hydriding are done or a single cycle of hydriding is done, followed by separation and pyrovacuum refining.

A separation process is done by a density differential technique, which is done such as by gravity, agitation motion, and a liquid-medium to fluidize the product stream, and the desired product of concentrated hydrided zirconium is placed in a pyrovacuum heating refinery. Under pyrovacuum heating conditions, the hydrogen of the hydrided zirconium is expelled, and a zirconium powder metal remains as a product.

Alternatively, a separation process is done by use of an acid bath treatment where the hydrided reactants are subjected to the acid bath to dissolve cobalt and to leave the hydrided zirconium. Thereafter, the concentrated hydrided zirconium is placed in a pyrovacuum heating refinery. Under pyrovacuum heating conditions, the hydrogen of the hydrided zirconium is expelled, and a zirconium powder metal remains as a product.

The zirconium powder metal may be further refined after pyrovacuum heating, by charging the basket 172 (FIG. 1) with the zirconium powder metal 174, and by electrochemically further refining within the molten salt electrolyte 164.

### Example 10

A crushed zirconium-aluminum alloy waste metal material is heated in a reactor vessel in a range between ambient temperature and 500° C., a 1.1 atm pressure, and a 100% anhydrous hydrogen stream is circulated within a closed rector. The crushed zirconium-aluminum alloy waste material is at a particle size passing 400 mesh. All other process acts and conditions used in Example 9 are followed, and each separation process alternative is then followed.

### Example 11

A crushed hafnium-aluminum/hafnium-iron alloy waste metal materials are heated in a reactor vessel in a range between ambient temperature and 500° C., a 1.1 atm pressure, and a 100% anhydrous hydrogen stream is circulated within a closed rector. The hafnium-aluminum/hafnium-iron alloy waste materials are at a particle size passing 100 mesh.

Monitoring of pressure in the closed reactor leads to process control of adding anhydrous hydrogen as a pressure drop occurs where hydrogen selectively hydrides the hafnium without significant hydriding of the aluminum nor of the iron. After a time period of observed pressure drop, a bleed stream is released until slightly above ambient pressure is observed, about 1% to 5% above the ambient, followed by a make-up stream of hydrogen that is added to the selected pressure set point such as 1.1 atm (gauge pressure compared to ambient at a nominal 1.0 atm).

After at least two cycles of hydriding, bleed, and makeup of the anhydrous hydrogen, the processed waste metal material is subjected to a separation process. Three cycles of hydriding are done or a single cycle of hydriding is done, followed by separation and pyrovacuum refining.

A separation process is done by a density differential technique, which is done such as by gravity, agitation motion, and a liquid-medium to fluidize the product stream, and the desired product of concentrated hydrided hafnium is placed in a pyrovacuum heating refinery. Under pyrovacuum heating conditions, the hydrogen of the hydrided hafnium is expelled, and a hafnium powder metal remains as a product.

Alternatively, a separation process is done by use of an acid bath treatment where the hydrided reactants are subjected to the acid bath to dissolve cobalt and to leave the hydrided hafnium. Thereafter, the concentrated hydrided titanium is placed in a pyrovacuum heating refinery. Under pyrovacuum heating conditions, the hydrogen of the hydrided hafnium is expelled, and a hafnium powder metal remains as a product.

Hafnium powder metal may be further refined after pyrovacuum heating, by charging the basket 172 (FIG. 1) with the hafnium powder metal 174, and by electrochemically further refining within the molten salt electrolyte 164.

### Example 12

A crushed hafnium-aluminum/hafnium-iron alloy waste metal materials are heated in a reactor vessel in a range between ambient temperature and 100° C., a 1.1 atm pressure, and a 100% anhydrous hydrogen stream is circulated within a closed rector. The crushed hafnium-aluminum/hafnium-iron alloy waste materials are at a particle size passing 400 mesh. All other process acts and conditions used in Example 11 are then followed, and each separation process alternative is then followed.

In some embodiments, at processing stage 330 in FIG. 3, the Item 174 in FIG. 1 is a hydrided and pyrovacuum refined metal that is taken from the processing stage 330 in FIG. 3 and fed as a feed material 174 to the electrorefining process at processing stage 210 as illustrated in FIGS. 1 and 2. The titanium (e.g., Examples 7 and 8), the zirconium (e.g., Examples 9 and 10), or the hafnium (e.g., Examples 11 and 12) is subjected to the molten salt electrochemical process described and illustrated in FIGS. 1 and 2, where the pyrovacuum refined material from any of Examples 7, 8, 9, 10, 11 or 12 is placed in the position of Item 174 in FIGS. 1 and 2, and the metal is further refined by the molten salt electrolyte process between the working electrode 166 and the counter electrode 168.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalent. For example, elements and features disclosed in relation to one embodiment may be combined with elements and features disclosed in relation to other embodiments of the disclosure.

What is claimed is:

1. A method of recovering a metal from a metal-containing waste material, comprising:
heating a metal-containing waste material under a hydrogen flow to form a hydrided metal material; and
removing hydrogen from the hydrided metal material to form an elemental metal or a metal oxide.

2. The method of claim 1, wherein heating a metal-containing waste material under a hydrogen flow to form a hydrided metal material comprises selectively hydriding one or more metals including metal compounds and metal oxides of the metal-containing waste material.

3. The method of claim 1, wherein heating a metal-containing waste material under a hydrogen flow to form a hydrided metal material comprises forming neodymium hydride, platinum hydride, or titanium hydride.

4. The method of claim 1, wherein removing hydrogen from the hydrided metal material to form an elemental metal or a metal oxide comprises removing the hydrogen in an electrochemical cell.

5. The method of claim 1, further comprising separating one or more metals of the metal-containing waste material from other metals of the metal-containing waste material using a molten salt electrochemical process to obtain a metal material, a physical separation, and combinations thereof.

6. The method of claim 5, further comprising annealing the metal material under reducing conditions.

7. The method of claim 1, wherein the hydrogen flow is maintained at a positive pressure under conditions that make up hydrogen as the hydrided metal material is formed.

8. The method of claim 1, further comprising separating the hydrided metal material from unhydrided metal material; and
wherein removing hydrogen from the hydrided metal material is done in a pyrovacuum stage.

9. The method of claim 1, further comprising separating the hydrided metal material from unhydrided metal material, comprising fluidizing the hydrided and unhydrided metal materials in a gravity environment to achieve a separation based upon density differences.

10. The method of claim 1, further comprising separating the hydrided metal material from unhydrided metal material, comprising acid bath treatment under conditions where the hydrided metal material is not dissolved and unhydrided metal materials are dissolved.

11. The method of claim 1, wherein the metal-containing waste material includes at least one of titanium, zirconium and hafnium, further comprising:
separating one or more metals of the metal-containing waste material from other metals of the metal-containing waste material using a molten salt electrochemical process to obtain titanium, zirconium or hafnium; and
annealing the metal-containing waste material.

12. A method of recovering a metal from a metal-containing waste material, comprising:
imposing an electrochemical environment upon a metal oxide material in a basket of an electrochemical cell immersed in a molten salt electrolyte, the molten salt electrolyte comprising:
a CaCl₂/CaO electrolyte composition, wherein the CaO constitutes between about 0.25 wt. % and about 5.0 wt. % of the molten salt electrolyte, and the CaCl₂ comprises up to 99.75 wt. % of the molten salt electrolyte,
a counter electrode of the electrochemical cell comprising a nonmetal selected from:
a ceramic selected from tin oxide, zinc ferrite, nickel ferrite, lithium ferrite and samarium ferrite;
a carbonaceous material;
a metal selected from palladium, ruthenium, and iridium; and
reducing the metal oxide material to a reduced metal in the molten salt electrolyte, wherein the reduced metal is selected from a transition metal, a refractory metal and a rare earth metal.

13. The method of claim 12, wherein the counter electrode comprises a metal selected from the group consisting of a glassy carbon, platinum, osmium, iridium, ruthenium, rhodium, palladium, silver, and gold.

14. The method of claim 12, prior to imposing an electrochemical environment upon a metal oxide material, the method further comprising:
heating a metal-containing waste material under a hydrogen flow to form a hydrided metal material; and
removing hydrogen from the hydrided metal material to form an elemental metal or a metal oxide.

15. The method of claim 12, further comprising rinsing the reduced metal to remove residual electrolyte.

16. The method of claim 12, further comprising:
rinsing the reduced metal to remove residual electrolyte; and
annealing the reduced metal wherein annealing is carried out under reducing conditions.

17. An electrochemical cell, comprising:
a working electrode immersed in a molten salt electrolyte;
the molten salt electrolyte comprising:
at least one of an alkali halide salt and an alkaline earth metal halide salt;
a metal compound comprising an oxidized metal or a partially hydrided metal in a basket located within the molten salt electrolyte, wherein the working electrode is in electrochemical contact with the metal compound and the basket;
a counter electrode immersed in the molten salt electrolyte, the counter electrode comprising at least one material selected from graphite, lithium iridate, lithium ruthenate, lithium rhodate, a tin oxide compound, a lithium tin oxygen compound, a lithium manganese oxygen compound, calcium ruthenate, a strontium ruthenium ternary compound, calcium iridate, strontium iridate, calcium platinate, strontium platinate, magnesium ruthenate, magnesium iridate, sodium ruthenate, sodium iridate, potassium iridate, potassium ruthenate, and nickel superalloys including rhenium containing nickel superalloys, ruthenium containing nickel superalloys, and rhenium-ruthenium nickel superalloys;
a reference electrode, selected from glassy carbon, nickel, nickel/nickel oxide, silver/silver chloride, a platinum group metal, a precious metal, and combinations thereof; and
an inert atmosphere.

18. The electrochemical cell of claim 17, wherein the molten salt electrolyte comprises a CaCl₂/CaO electrolyte composition, wherein the CaO constitutes between about 0.25 wt. % and about 5.0 wt. % of the molten salt electrolyte, and the CaCl₂ comprises up to 99.75 wt. % of the molten salt electrolyte.

19. The electrochemical cell of claim 17, wherein:
the metal compound is selected from oxide compounds of scandium, titanium, vanadium, chromium, manganese, iron, cobalt, nickel, copper, zinc, yttrium, zirconium, niobium, molybdenum, ruthenium, rhodium, palladium, silver, cadmium, lanthanum, hafnium, tantalum, tungsten, rhenium, osmium, iridium, platinum, gold, vanadium, cerium, dysprosium, erbium, europium, gadolinium, holmium, lanthanum, lutetium, neodymium, praseodymium, promethium, samarium, scandium, terbium, thulium, ytterbium, and yttrium.

20. The electrochemical cell of claim 17, wherein:
the metal compound is selected from partial hydrided compounds of scandium, titanium, vanadium, chromium, manganese, iron, cobalt, nickel, copper, zinc, yttrium, zirconium, niobium, molybdenum, ruthenium, rhodium, palladium, silver, cadmium, lanthanum, hafnium, tantalum, tungsten, rhenium, osmium, iridium, platinum, gold, vanadium, cerium, dysprosium, erbium, europium, gadolinium, holmium, lanthanum, lutetium, neodymium, praseodymium, promethium, samarium, scandium, terbium, thulium, ytterbium, and yttrium.
